(19) United States
(12) Patent Application Publication
(10) Pub. No.: US 2013/0201004 A1
(43) Pub. Date: Aug. 8, 2013

(54) Proximity Devices and Systems that Support Multiple Formats

(71) Applicant: Identive Group, Inc., Santa Ana, CA (US)

(72) Inventors: Jason Hart, Fremont, CA (US); Matthew Herscovitch, Fremont, CA (US); Peter Lowe, Peyton, CO (US); Joseph Tassone, Bedford, MA (US)

(73) Assignee: IDENTIVE GROUP, INC., Santa Ana, CA (US)

(21) Appl. No.: 13/747,157

(22) Filed: Jan. 22, 2013

Related U.S. Application Data
(60) Provisional application No. 61/589,047, filed on Jan. 20, 2012.

(51) Int. Cl. G06K 19/07

(52) U.S. Cl. CPC G06K 19/0723
USPC 340/10.1

(57) ABSTRACT

Described herein is a radio-frequency identification (RFID) credential configured to provide a plurality of message formats. The RFID credential includes a low-frequency proximity chip. The proximity chip includes a controller having a protocol sequencing module, an analog front end, a modes register, and a modulator. The protocol sequencing module is programmed to deliver messages associated with the plurality of message formats to the analog front end using the modes register and the modulator, the delivery of the messages occurring in a sequential manner based on the message format of the message. The modes register is configured to store a plurality of message formats, and one or more bits in each message format identify the message format type.

### RELATED APPLICATIONS

This application claims priority to U.S. Provisional Patent Application No. 61/589,047, filed Jan. 20, 2012.

### FIELD OF THE INVENTION

The subject matter of the application relates generally to a proximity chip, reader devices, and system that supports multiple message formats and a programming device for programming the proximity chip and configuring the system.

### BACKGROUND

Traditionally, card readers are associated with an access point to a system or building. In a physical access control system, card readers are commonly located at a door and each person who is authorized to enter the premises carries an access card (or similar token device) that interacts with the readers. The access card can contain a radio-frequency identification (RFID) chip or an application-specific integrated circuit (ASIC) which stores a code number in its memory. The code number can be a single value or stored in multiple fields that correspond to, e.g., a serial number and a facility code to designate a building or series of buildings. The ASIC within the card is connected to an antenna, and the card is able to communicate to the reader using an inductive coupling, commonly referred to as RFID.

The reader typically sends out an interrogating signal at 125 KHz to 134 KHz, commonly known as Low Frequency (LF). Other frequencies are also used; for example, another frequency band known as HF operates at the singular frequency of 13.56 MHz. The card is presented to the reader (e.g., by being placed in proximity to the reader), and the reader reads a message from the card. The reader is programmed to strip the message of its overhead structure, and reformat the message in a standardized data stream which the reader sends to a control panel. For example, the standardized format can be Wiegand code. The control panel may or may not recognize the card as belonging to the population of authorized entrants. If the card is recognized as authorized, the panel takes appropriate action to open the door which generally involves setting a relay that sends an electric current to activate a device at the door (e.g., a magnetic strike or lock).

Access cards can include both HF and LF ASICs to provide more than one signal or protocol. However, it is not practical to have two or more LF or HF ASICs with separate antennas in the same access card because the ASICs and antennas interfere with each other and confuse the card reader.

Frequently, the ASIC used in LF cards is the Atmel® T5557, or one of its variants (e.g., Ref2), as described in the Atmel® Multifunctional 330-bit Read/Write RF Identification IC T5557 specification, dated March 2006. FIG. 1 is a block diagram of a chip 100 used for LF and having only one message format (e.g., a T5557). This ASIC chip 100 can be configured to produce different message types and modulation methods. The ASIC chip 100 includes several components, including a modulator, a mode register, a controller, test logic, a memory (e.g., a 1K bit erasable programmable read-only memory (EPROM)), an input register, a high-voltage (HV) generator, a bit-rate generator, a write decoder, an analog front end, and two coils.

FIG. 2 is a diagram of a structure of a message block 200 configured to produce one message format. As shown in FIG. 2, the message block includes thirty-two message bits 202 (e.g., corresponding to a password).

The manufacturer of the T5557 or similar access cards uses a programming device to program the cards to have the desired message structure and message value by exposing the cards to a magnetic field, as if a reader was reading the card. The programming device indicates that it wants to program the ASIC by a special action, e.g., switching off the excitation signal for a predetermined length of time and then resuming the signal. On detecting the timed gap in the excitation signal, the ASIC stops sending a signal and starts listening for instructions from the programming device. Generally, the first piece of information that the programming device sends to the ASIC is a 32-bit password. Typically, ASICs from a particular manufacturer have the same password. If the programming device sends an incorrect password, the ASIC stops listening for instructions from the programming device (i.e., exits the programming mode) and resumes responding to a read signal (i.e., the read mode).

Typically, a person may have to carry several access cards (e.g., for entry into facilities having different access systems). The access cards may differ in their frequency, code structure or, in the case where the cards are made by different manufacturers, different modulation methods, message structures or formats are employed. For example, access cards made by one manufacturer may use frequency-shift keying (FSK) modulation, and access cards made by another manufacturer may use phase-shift keying (PSK) modulation. In another example, two different manufacturers that both use FSK modulation may use different message blocking techniques. In yet another example, different manufacturers may use different number of bits in their messages and different encoding or bit grouping mechanisms.

### SUMMARY OF THE INVENTION

Because it is inconvenient to carry several access cards, the techniques described herein provide for a proximity chip and associated reader devices and systems that support multiple message formats and a programming device and systems for programming the proximity chip and configuring readers to accommodate the multiple message formats.

The invention, in one aspect, features a radio-frequency identification (RFID) credential configured to be capable of providing a plurality of message formats. The RFID credential includes a low-frequency proximity chip. The proximity chip includes a controller having a protocol sequencing module, an analog front end, a modes register, and a modulator. The protocol sequencing module is programmed to deliver messages associated with the plurality of message formats to the analog front end using the modes register and the modulator, the delivery of the messages occurring in a sequential manner based on the message format of the message. The modes register is configured to store a plurality of message formats, and one or more bits in each message format identify the message format type.

The invention, in another aspect, features an RFID credential programming device configured to provide formatting instructions to a low-frequency proximity chip of an RFID credential. The device includes a transmission antenna configured to communicate with a low-frequency proximity chip of an RFID credential, and a processor configured to generate information to be transmitted to the low-frequency proximity chip, wherein the information includes a password to be stored on the proximity chip for formatting in a plurality of message formats.

The invention, in another aspect, features an RFID credential programming device configured to provide formatting instructions to a low-frequency proximity chip of an RFID credential. The device includes a transmission antenna configured to communicate with a low-frequency proximity chip of an RFID credential, and a processor configured to generate information to be transmitted to the low-frequency proximity chip, wherein the information includes different codes representing different message formats to be stored on the proximity chip for formatting in a plurality of message formats.

The invention, in another aspect, features an RFID credential reading device configured to receive different formatting instructions from a low-frequency proximity chip of an RFID credential. The device includes a receiving antenna configured to communicate with a low-frequency proximity chip of an RFID credential, and a processor configured to receive information transmitted from the low-frequency proximity chip, wherein the information includes different codes representing different message formats to be read and decoded from the plurality of message formats available.

The invention, in another aspect, features an RFID credential reading device configured to receive differently formatted messages from a low-frequency proximity chip of an RFID credential generating different messaging formats, wherein the messages are (i) relayed in a predetermined order, (ii) scanned in an intelligent order, or (iii) automatically selected based on detection of modulation scheme parameters.

The invention, in another aspect, features a computerized system for programming an RFID credential. The system includes a plurality of access control panels, one or more server computing devices coupled to one or more databases, a plurality of RFID credential reading devices, and one or more RFID credential programming devices. The system is configured to instruct one or more of the plurality of reading devices to be capable of writing information to the RFID credential, instruct one or more of the plurality of reading devices to be capable of reading messages in a specified message format from the RFID credential, instruct one or more of the plurality of reading devices to store message format information associated with messages received from the RFID credential, and provide instructions to the RFID credential to update the plurality of message formats stored on the RFID credential.

The invention, in another aspect, features a method for providing a plurality of message formats via an RFID credential comprising a low-frequency proximity chip. A modes register of the proximity chip stores a plurality of message formats, where one or more bits in each message format identifies the message format type. A protocol sequencing module of the proximity chip delivers messages associated with the plurality of message formats to an analog front end of the chip using the modes register and a modulator, where the delivery of the messages occurs in a sequential manner based on the message format of the message.

The invention, in another aspect, features a method for providing formatting instructions to a low-frequency proximity chip of an RFID credential. A processor of an RFID credential programming device generates information to be transmitted to the low-frequency proximity chip, where the information includes a password to be stored on the proximity chip for formatting in a plurality of message formats. A transmission antenna of the RFID credential programming device communicates the information to the low-frequency proximity chip of the RFID credential.

The invention, in another aspect, features a method for receiving formatting instructions from a low-frequency proximity chip of an RFID credential. A receiving antenna of an RFID credential reading device initiates a communication event with the low-frequency proximity chip of the RFID credential. A processor of the RFID credential reading device receives information transmitted from the low-frequency proximity chip, where the information includes different codes representing different message formats to be read and decoded from the plurality of message formats available.

The invention, in another aspect, features a method for receiving differently formatted messages from a low-frequency proximity chip of an RFID credential. The low-proximity chip generates a plurality of different messaging formats. The low-proximity chip transmits, to an RFID credential reading device, messages based on the plurality of different messaging formats, where the messages are (i) relayed in a predetermined order, (ii) scanned in an intelligent order, or (iii) automatically selected based on detection of modulation scheme parameters.

The invention, in another aspect, features a computerized method for programming an RFID credential capable of generating a plurality of message formats. A computing device instructs one or more of a plurality of RFID credential reading devices to be capable of writing information to the RFID credential. The computing device instructs one or more of the plurality of RFID credential reading devices to be capable of reading messages in a specified message format from the RFID credential. The computing device instructs one or more of the plurality of RFID credential reading devices to store message format information associated with messages received from the RFID credential. The computing device provides instructions to one or more of the plurality of the RFID credential reading devices to update the plurality of message formats stored on the RFID credential.

In some embodiments, any of the above aspects can have one or more of the following features. In some embodiments, the proximity chip is an application-specific integrated circuit (ASIC). In some embodiments, delivery of the messages occurs in an intelligent manner. In some embodiments, the intelligent manner includes a last-in-first-out priority or a first-in-first-out priority. In some embodiments, delivery of the messages occurs automatically based on detection of modulation scheme parameters.

In some embodiments, the RFID credential includes a memory module. In some embodiments, the RFID credential includes a second proximity chip operating at a different frequency than the low-frequency proximity chip. In some embodiments, the operating frequency of the second proximity chip is 13.56 MHz.

In some embodiments, the physical form of the credential is a card. In some embodiments, the physical form of the credential is a key fob. In some embodiments, the physical form of the credential is a token. In some embodiments, the messages delivered by the protocol sequencing module are passwords associated with an access control system. In some embodiments, the plurality of message formats include frequency-shift keying (FSK) modulation format and phase-shift keying (PSK) modulation format. In some embodiments, each message format uses different message blocking. In some embodiments, the plurality of message formats include a sequence of bits containing the message. In some embodiments, each message format contains a different number of bits.

Other aspects and advantages of the invention will become apparent from the following detailed description, taken in conjunction with the accompanying drawings, illustrating the principles of the invention by way of example only.

### BRIEF DESCRIPTION OF THE FIGURES

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a low-frequency proximity chip configured to produce only one message format, for use with an RFID credential, as illustrated in the art.

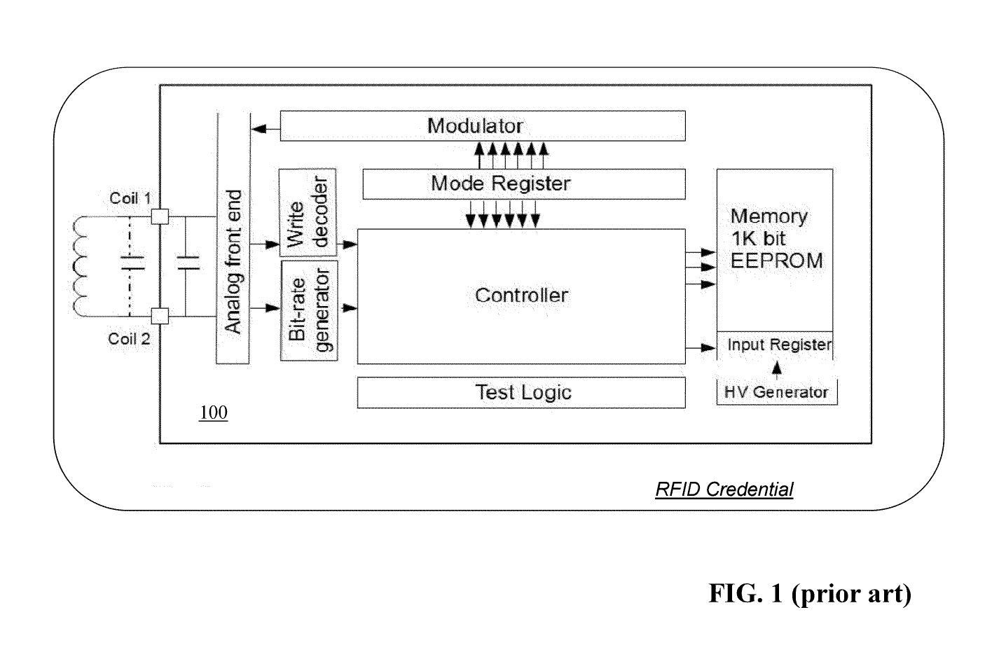

FIG. 2 is a diagram of a structure of a message block configured to produce one message format, as illustrated in the art.

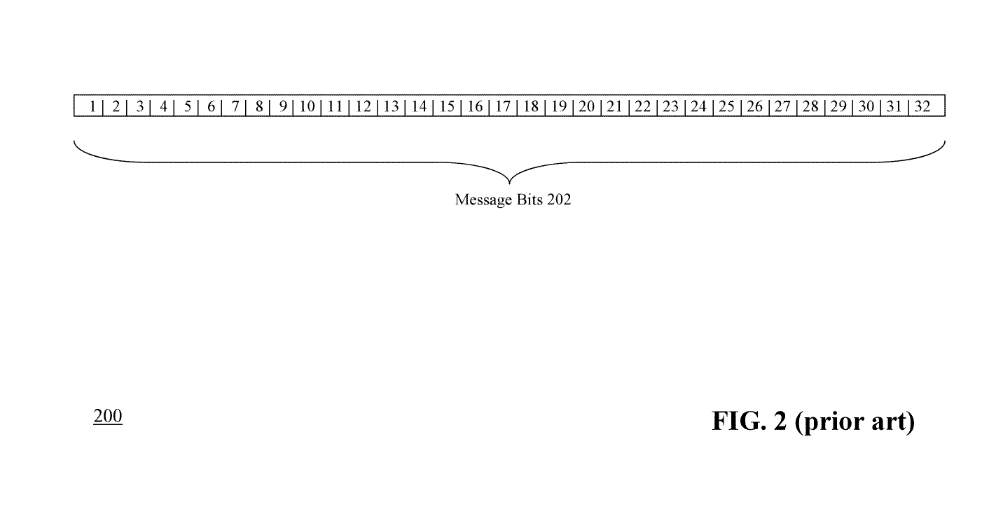

FIG. 3 is a block diagram of a low-frequency proximity chip configured to produce a plurality of message formats, for use with an RFID credential, in accordance with embodiments of the present invention.

FIG. 4 is a diagram of a structure of a message block configured to produce a plurality of message formats, in accordance with embodiments of the present invention.

FIG. 5 is a block diagram of a programming device configured to provide message format instructions to a low-frequency proximity chip of an RFID credential, in accordance with embodiments of the present invention.

FIG. 6 is a block diagram of an access control system configured to provide support for different message formats at read/write and read-only, in accordance with embodiments of the present invention.

FIG. 7 is a flow diagram of a method for providing a plurality of message formats via an RFID credential comprising a low-frequency proximity chip, in accordance with embodiments of the present invention.

FIG. 8 is a flow diagram of a method for providing formatting instructions to a low-frequency proximity chip of an RFID credential using the system of FIG. 6, in accordance with embodiments of the present invention.

FIG. 9 is a flow diagram of a method for providing formatting instructions to a low-frequency proximity chip of an RFID credential using the system 600 of FIG. 6, in accordance with embodiments of the present invention.

FIG. 10 is a flow diagram of a method for receiving formatting instructions from a low-frequency proximity chip of an RFID credential using the system 600 of FIG. 6, in accordance with embodiments of the present invention.

FIG. 11 is a flow diagram of a method for receiving differently formatted messages from a low-frequency proximity chip using the system 600 of FIG. 6, in accordance with embodiments of the present invention.

FIG. 12 is a flow diagram of a method for programming an RFID credential capable of generating a plurality of message formats using the system 600 of FIG. 6, in accordance with embodiments of the present invention.

### DETAILED DESCRIPTION

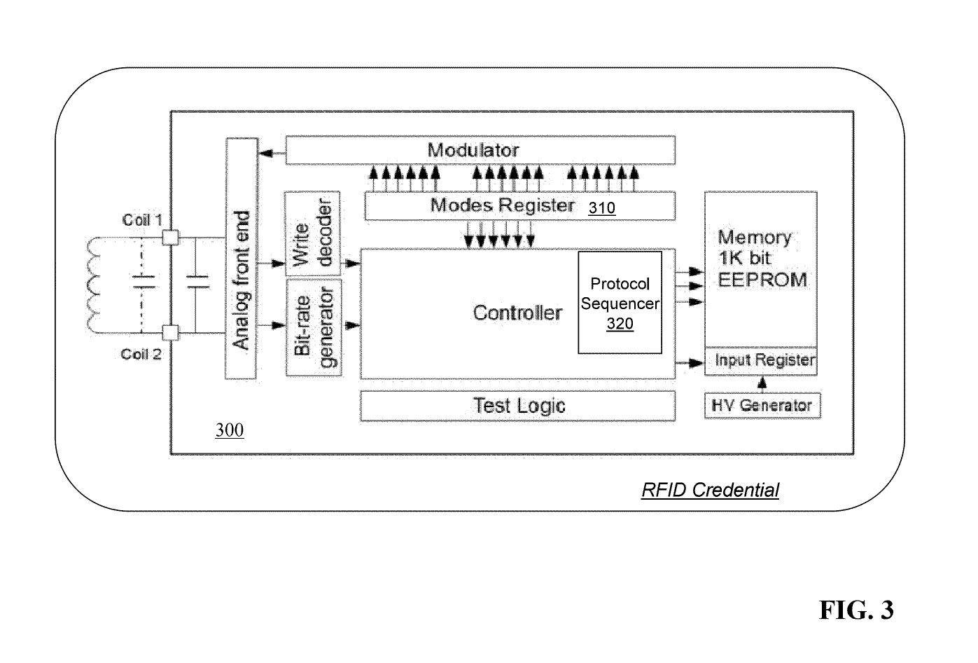

FIG. 3 is a block diagram of a low-frequency proximity chip 300 (e.g., ASIC chip) configured to produce a plurality of message formats, for use with an RFID credential, in accordance with embodiments of the present invention. The RFID credential can take the form of a card, a key fob, a button, a token, or other types of access credentials. The chip 300 in FIG. 3 accommodates a plurality of message formats due to the provision of additional storage space in the modes register 310 and sequencing logic (e.g., protocol sequencer 320) in the controller. While the proximity chip shown in FIG. 3 is a preferred embodiment, it should be appreciated that alternative implementations utilizing other control logic programming methods and/or external analog circuitry can be envisioned and are within the scope of the invention.

The proximity chip 300 shown in FIG. 3 has a plurality of format modes. When the proximity chip 300 is in read mode, the chip 300 transmits messages that are formatted by cycling through the plurality of format modes in a sequential manner (e.g., format one→format two→format three→format one). In some embodiments, the proximity chip 300 transmits messages that are formatted by selecting a format mode in an intelligent manner. For example, the proximity chip 300 may cycle through the format modes using a last-in-first-out priority or a first-in-first-out priority. In another example, the proximity chip 300 may automatically select a format mode based on detection of modulation scheme parameters. If one of the format modes has not been programmed, then the format mode is skipped and the other modes that have been programmed are cycled through in sequence. If system requirements dictate one of the modes to be HF, then HF hardware may be built separately into the RFID credential, and used and programmed independently of the LF hardware of FIG. 3. In some embodiments, the LF portion of the card can be programmed by a programming device, for example, as used for conventional LF cards.

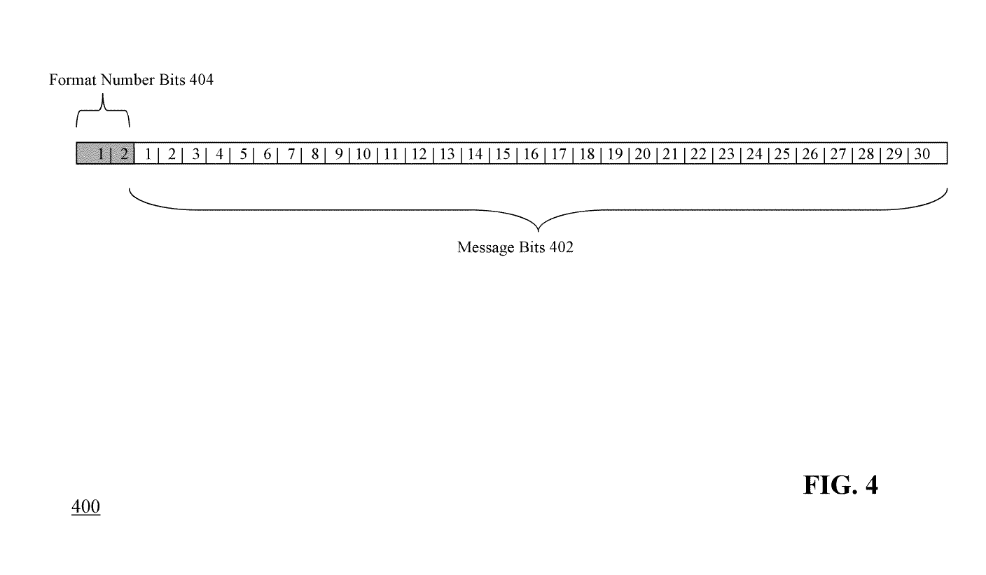

FIG. 4 is a diagram of a structure of a message block 400 configured to produce a plurality of message formats, in accordance with embodiments of the present invention. The message block includes two format number bits 404 (e.g., bits 1 and 2 at the beginning of the block) that designate the corresponding message format to be used in conjunction with the message. The message block in FIG. 4 also includes thirty message bits 402. To manage the plurality of formats, the values assigned to the format number bits 404 indicate the message format type. A card reader that receives a message from the proximity chip can interpret the format number bits 404 and determine the message format of the corresponding message. In the embodiment of FIG. 4, there are thirty password bits; however, if a proximity chip with additional formats is required, the message block can contain additional format bits and the message can become smaller. In some embodiments, the overall number of bits available in the message block can be expanded.

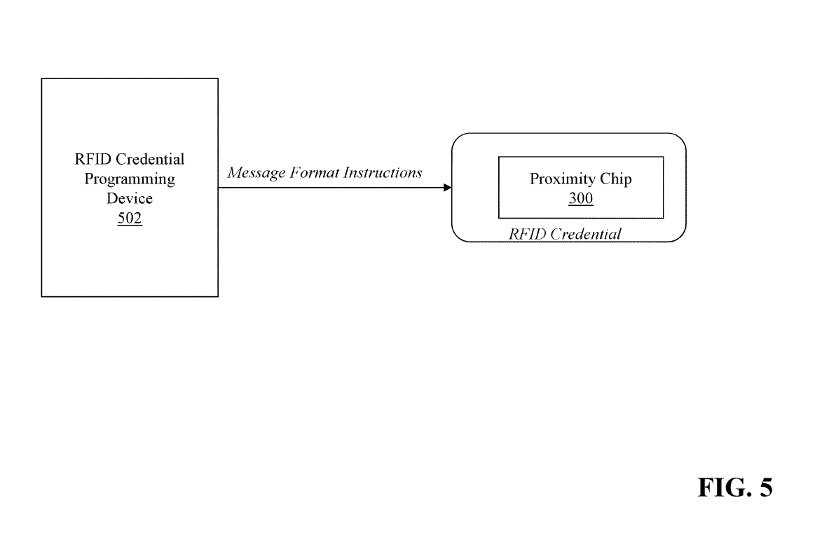

FIG. 5 is a block diagram of a programming device 502 configured to provide message format instructions and other programming instructions to a low-frequency proximity chip of an RFID credential (e.g., chip 300 of FIG. 3). The programming device 502 includes a transmitting antenna that transmits an excitation signal to nearby RFID credentials that activates the antenna in the RFID credential. The programming device 502 also includes a processor that generates message format instructions and other programming instructions for delivery and storage on the proximity chip 300.

The programming device 502 programs the proximity chip by an out-of-band signaling method, e.g., switching off the excitation signal for a predetermined length of time and then resuming the signal, or other similar predetermined switching sequences. On detecting the timed gap or sequence in the excitation signal, the proximity chip 300 stops sending a signal and starts listening for instructions from the programming device 502. The programming device 502 transmits the message format instructions to the proximity chip 300, including the number of bits assigned to the message format (e.g., message format bits 404 of FIG. 4) and the number of bits assigned to the message content (e.g., message bits 402 of FIG. 4).

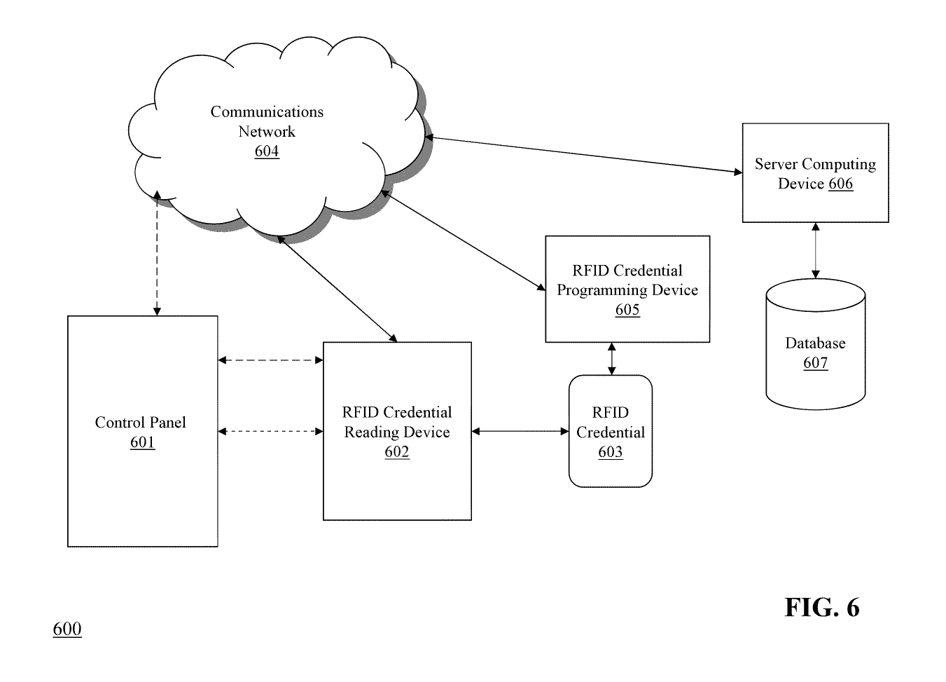

FIG. 6 is a block diagram of an access control system 600 configured to provide support for different message formats at read/write and read-only, in accordance with embodiments of the present invention. The system 600 in FIG. 6 includes a control panel 601 connected to an RFID credential reading device 602 via a connection (e.g., Wiegand interface). The system 600 also includes an RFID credential 603 (e.g., smart card, key fob, token) that is presented to the RFID credential reading device 602 using an RFID signal, and the RFID credential reading device 602 receives a message from the RFID credential 603.

The system 600 also includes an RFID credential programming device 605 that can read messages from, and write messages to, the RFID credential 603. In some embodiments, the RFID credential reading device 602 and the RFID credential programming device 605 can be combined into a single device capable of reading, writing, and providing configuration instructions to the RFID credential 603. The system 600 further includes communications network 604 that connects the RFID credential reading device 602 and the RFID credential programming device 605 to other devices (e.g., a server computing device 606 connected to database 607) directly or through control panel 601. In some embodiments, the server computing device 606 is programmed to provide message format information and instructions to the RFID credential reading device 602 and/or the RFID credential programming device 605. The message format information can be subsequently communicated to the RFID credential 603. In this way, the message format information on RFID credentials using the system 600 can be updated automatically and uniformly based on centralized information. In addition, the reading device 602 can be updated with the capability to read a plurality of message formats from RFID credentials, or be restricted to a subset of message formats.

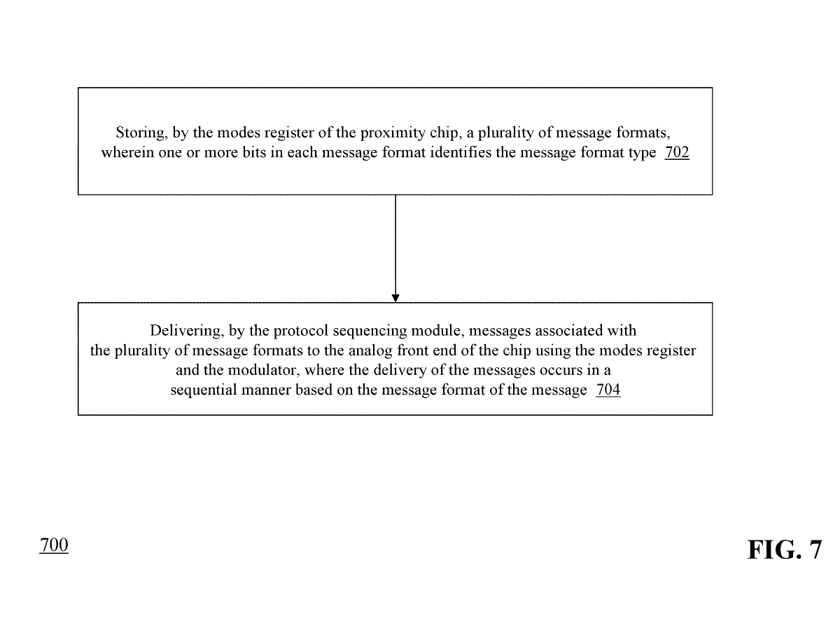

FIG. 7 is a flow diagram of a method 700 for providing a plurality of message formats via an RFID credential comprising a low-frequency proximity chip (e.g., chip 300 of FIG. 3). The modes register (e.g., modes register 310 of FIG. 3) stores (702) a plurality of message formats, where one or more bits in each message format identifies the message format type. The protocol sequencing module (e.g., protocol sequencer 320 of FIG. 3) delivers (704) messages associated with the plurality of message formats to the analog front end of the chip using the modes register 310 and the modulator, where the delivery of the messages occurs in a sequential manner based on the message format of the message.

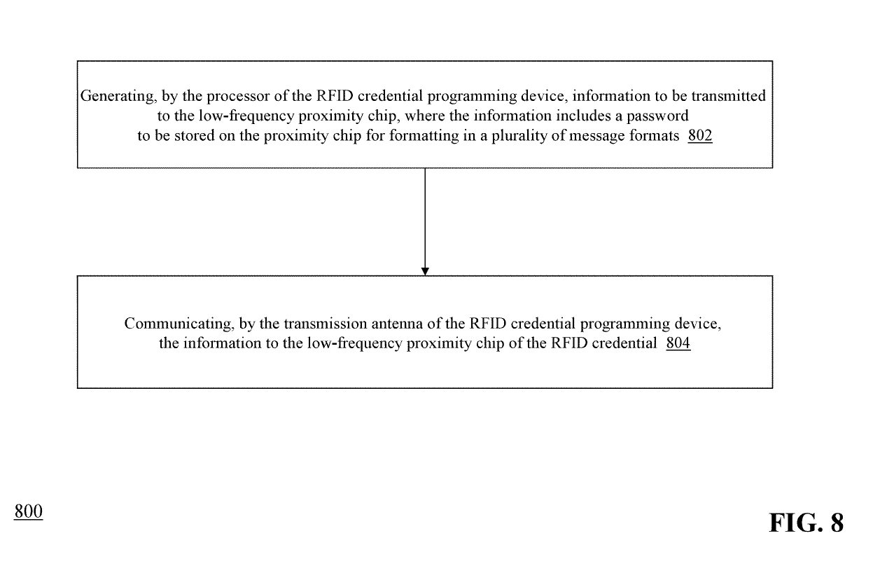

FIG. 8 is a flow diagram of a method 800 for providing formatting instructions to a low-frequency proximity chip (e.g., chip 300 of FIG. 3) of an RFID credential (e.g., credential 603), using the system 600 of FIG. 6. A processor of an RFID credential programming device 605 generates (802) information to be transmitted to the low-frequency proximity chip, where the information includes a password to be stored on the proximity chip for formatting in a plurality of message formats. A transmission antenna of the RFID credential programming device 605 communicates (804) the information to the low-frequency proximity chip of the RFID credential 603.

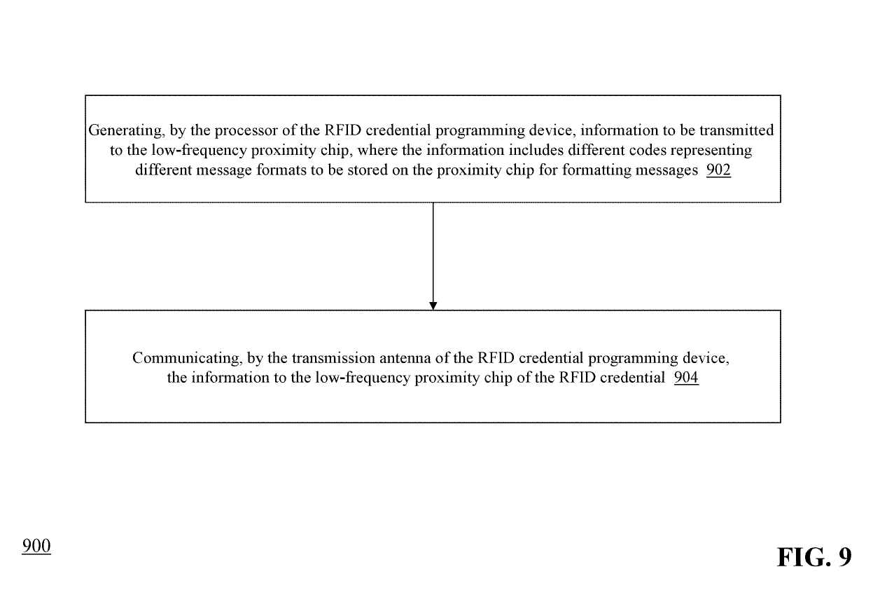

FIG. 9 is a flow diagram of a method 900 for providing formatting instructions to a low-frequency proximity chip (e.g., chip 300 of FIG. 3) of an RFID credential (e.g., credential 603), using the system 600 of FIG. 6. A processor of an RFID credential programming device 605 generates (902) information to be transmitted to the low-frequency proximity chip, where the information includes different codes representing different message formats to be stored on the proximity chip for formatting messages. A transmission antenna of the RFID credential programming device 605 communicates (904) the information to the low-frequency proximity chip of the RFID credential 603.

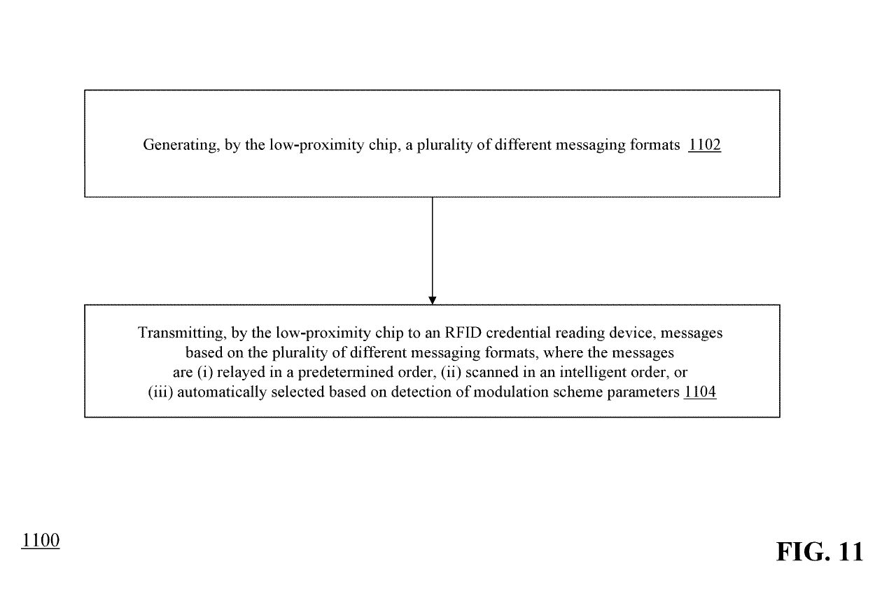

FIG. 10 is a flow diagram of a method 1000 for receiving formatting instructions from a low-frequency proximity chip (e.g., chip 300 of FIG. 3) of an RFID credential (e.g., credential 603), using the system 600 of FIG. 6. The receiving antenna of an RFID credential reading device 602 initiates (1002) a communication event with the low-frequency proximity chip of the RFID credential 603. The processor of the RFID credential reading device 602 receives (1004) information transmitted from the low-frequency proximity chip, where the information includes different codes representing different message formats to be read and decoded from the plurality of message formats available.

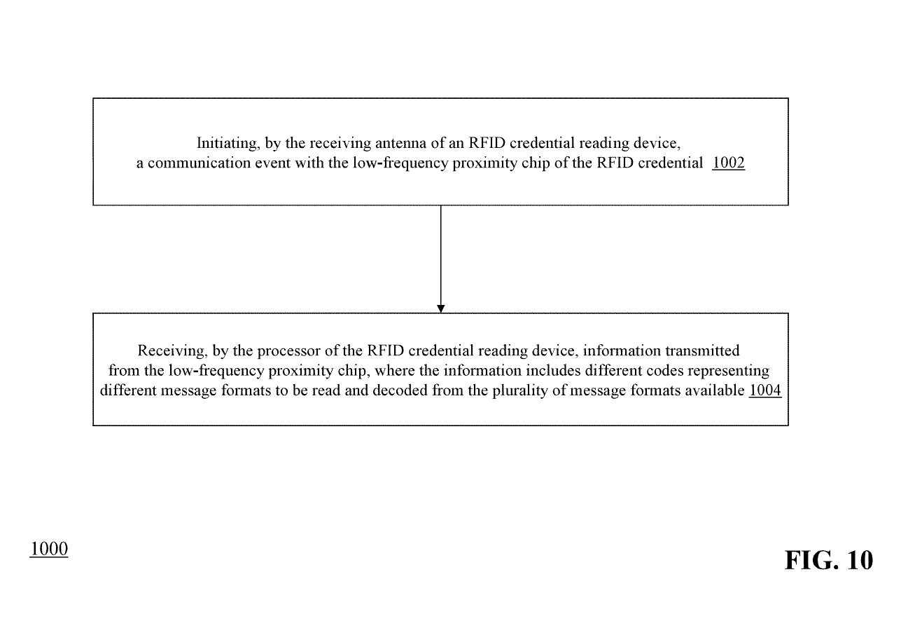

FIG. 11 is a flow diagram of a method 1100 for receiving differently formatted messages from a low-frequency proximity chip (e.g., chip 300 of FIG. 3), using the system 600 of FIG. 6. The low-proximity chip generates (1102) a plurality of different messaging formats. The low-proximity chip transmits (1104), to the RFID credential reading device, messages based on the plurality of different messaging formats, where the messages are (i) relayed in a predetermined order, (ii) scanned in an intelligent order, or (iii) automatically selected based on detection of modulation scheme parameters.

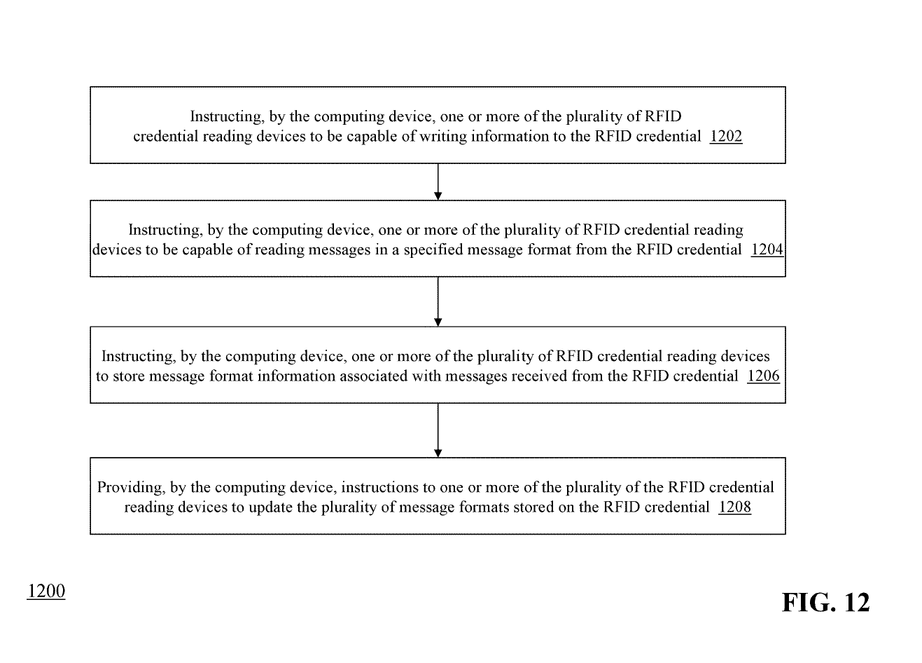

FIG. 12 is a flow diagram of a method 1200 for programming an RFID credential (e.g., credential 603) capable of generating a plurality of message formats, using the system 600 of FIG. 6. The computing device (e.g., server computing device 606) instructs (1202) one or more of a plurality of RFID credential reading devices (e.g., device 602) to be capable of writing information to the RFID credential 603. The computing device 606 instructs (1204) one or more of the plurality of RFID credential reading devices (e.g., device 602) to be capable of reading messages in a specified message format from the RFID credential 603. The computing device 606 instructs (1206) one or more of the plurality of RFID credential reading devices (e.g., device 602) to store message format information associated with messages received from the RFID credential 603. The computing device 606 provides (1208) instructions to one or more of the plurality of RFID credential reading devices (e.g., device 602) to update the plurality of message formats stored on the RFID credential 603.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A radio-frequency identification (RFID) credential configured to provide a plurality of message formats, the RFID credential comprising a low-frequency proximity chip including:
a controller having a protocol sequencing module;
an analog front end;
a modes register; and
a modulator;
wherein the protocol sequencing module is programmed to deliver messages associated with the plurality of message formats to the analog front end using the modes register and the modulator, the delivery of the messages occurring in a sequential manner based on the message format of the message;
the modes register is configured to store a plurality of message formats; and
one or more bits in each message format identify the message format type.

2. The RFID credential of claim 1, wherein the proximity chip is an application-specific integrated circuit (ASIC).

3. The RFID credential of claim 1, further comprising a memory module.

4. The RFID credential of claim 1, wherein the delivery of the messages occurs in an intelligent manner.

5. The RFID credential of claim 4, wherein the intelligent manner includes a last-in-first-out priority or a first-in-first-out priority.

6. The RFID credential of claim 1, wherein the delivery of the messages occurs automatically based on detection of modulation scheme parameters.

7. The RFID credential of claim 1, further comprising a second proximity chip operating at a different frequency than the low-frequency proximity chip.

8. The RFID credential of claim 7, wherein the operating frequency of the second proximity chip is 13.56 MHz.

9. The RFID credential of claim 1, wherein the physical form of the credential is a card.

10. The RFID credential of claim 1, wherein the physical form of the credential is a key fob.

11. The RFID credential of claim 1, wherein the physical form of the credential is a token.

12. The RFID credential of claim 1, wherein the messages delivered by the protocol sequencing module are passwords associated with an access control system.

13. The RFID credential of claim 1, wherein the plurality of message formats include frequency-shift keying (FSK) modulation format and phase-shift keying (PSK) modulation format.

14. The RFID credential of claim 1, wherein each message format uses different message blocking.

15. The RFID credential of claim 1, wherein the plurality of message formats include a sequence of bits containing the message.

16. The RFID credential of claim 15, wherein each message format contains a different number of bits.

17. An RFID credential programming device configured to provide formatting instructions to a low-frequency proximity chip of an RFID credential, the device comprising:
a transmission antenna configured to communicate with a low-frequency proximity chip of an RFID credential; and
a processor configured to generate information to be transmitted to the low-frequency proximity chip, wherein the information includes a password to be stored on the proximity chip for formatting in a plurality of message formats.

18. An RFID credential programming device configured to provide formatting instructions to a low-frequency proximity chip of an RFID credential, the device comprising:
a transmission antenna configured to communicate with a low-frequency proximity chip of an RFID credential; and
a processor configured to generate information to be transmitted to the low-frequency proximity chip, wherein the information includes different codes representing different message formats to be stored on the proximity chip for formatting messages.

19. An RFID credential reading device configured to receive formatting instructions from a low-frequency proximity chip of an RFID credential, the device comprising:
a receiving antenna configured to communicate with a low-frequency proximity chip of an RFID credential; and
a processor configured to receive information transmitted from the low-frequency proximity chip, wherein the information includes different codes representing different message formats to be read and decoded from the plurality of message formats available.

20. An RFID credential reading device configured to receive differently formatted messages from a low-frequency proximity chip of an RFID credential generating different messaging formats, wherein the messages are (i) relayed in a predetermined order, (ii) scanned in an intelligent order, or (iii) automatically selected based on detection of modulation scheme parameters.

21. An RFID credential reading device configured to read and decode messages and message formats received from the RFID credential of claim 1.

22. An RFID credential programming device configured to read information from and write information to the RFID credential of claim 1.

23. A system for programming the RFID credential of claim 1, the system comprising:
a plurality of access control panels;
one or more server computing devices coupled to one or more databases;
a plurality of RFID credential reading devices; and
one or more RFID credential programming devices;
wherein the system is configured to:
instruct one or more of the plurality of reading devices to be capable of writing information to the RFID credential;
instruct one or more of the plurality of reading devices to be capable of reading messages in a specified message format from the RFID credential;
instruct one or more of the plurality of reading devices to store message format information associated with messages received from the RFID credential; and
provide instructions to the RFID credential to update the plurality of message formats stored on the RFID credential.

24. A method for providing a plurality of message formats via an RFID credential comprising a low-frequency proximity chip, the method comprising:
storing, by a modes register of the proximity chip, a plurality of message formats, wherein one or more bits in each message format identifies the message format type; and
delivering, by a protocol sequencing module of the proximity chip, messages associated with the plurality of message formats to an analog front end of the chip using the modes register and a modulator, wherein the delivery of the messages occurs in a sequential manner based on the message format of the message.

25. A method for providing formatting instructions to a low-frequency proximity chip of an RFID credential, the method comprising:
generating, by a processor of an RFID credential programming device, information to be transmitted to the low-frequency proximity chip, wherein the information includes a password to be stored on the proximity chip for formatting in a plurality of message formats; and
communicating, by a transmission antenna of the RFID credential programming device, the information to the low-frequency proximity chip of the RFID credential.

26. A method for providing formatting instructions to a low-frequency proximity chip of an RFID credential, the method comprising:
generating, by a processor of an RFID credential programming device, information to be transmitted to the low-frequency proximity chip, wherein the information includes different codes representing different message formats to be stored on the proximity chip for formatting messages; and
communicating, by a transmission antenna of the RFID credential programming device, the information to the low-frequency proximity chip of the RFID credential.

27. A method for receiving formatting instructions from a low-frequency proximity chip of an RFID credential, the method comprising:
initiating, by a receiving antenna of an RFID credential reading device, a communication event with the low-frequency proximity chip of the RFID credential; and
receiving, by a processor of the RFID credential reading device, information transmitted from the low-frequency proximity chip, wherein the information includes different codes representing different message formats to be read and decoded from the plurality of message formats available.

28. A method for receiving differently formatted messages from a low-frequency proximity chip of an RFID credential, the method comprising:
generating, by the low-proximity chip, a plurality of different messaging formats; and
transmitting, by the low-proximity chip to an RFID credential reading device, messages based on the plurality of different messaging formats, wherein the messages are (i) relayed in a predetermined order, (ii) scanned in an intelligent order, or (iii) automatically selected based on detection of modulation scheme parameters.

29. A computerized method for programming an RFID credential capable of generating a plurality of message formats, the method comprising:
instructing, by a computing device, one or more of a plurality of RFID credential reading devices to be capable of writing information to the RFID credential;
instructing, by the computing device, one or more of the plurality of RFID credential reading devices to be capable of reading messages in a specified message format from the RFID credential;
instructing, by the computing device, one or more of the plurality of RFID credential reading devices to store message format information associated with messages received from the RFID credential; and
providing, by the computing device, instructions to one or more of the plurality of the RFID credential reading devices to update the plurality of message formats stored on the RFID credential.
